(19) United States
(12) Patent Application Publication
(10) Pub. No.: US 2024/0294848 A1
(43) Pub. Date: Sep. 5, 2024

(54) BIO-BASED CLEANER ADDITIVE

(71) Applicant: Solugen, Inc., Houston, TX (US)

(72) Inventors: Jun Su An, Houston, TX (US); LoongYi Tan, Houston, TX (US); Frederyk Ngantung, Houston, TX (US); Catherine Gonzalez, Houston, TX (US); Chris Arceo, Richmond, TX (US); Jason Helander, Richmond, TX (US); Jihye Kim, Sugar Land, TX (US); Darlen Galicia, Houston, TX (US); Fahim Ahmed, Greensboro, NC (US)

(73) Assignee: Solugen, Inc., Houston, TX (US)

(21) Appl. No.: 18/566,061

(22) PCT Filed: Jun. 9, 2022
(86) PCT No.: PCT/US2022/032868

§ 371 Date: Nov. 30, 2023

Related U.S. Application Data
(60) Provisional application No. 63/253,066, filed on Oct. 6, 2021.
(60) Provisional application No. 63/203,634, filed on Jul. 27, 2021.
(60) Provisional application No. 63/208,601, filed on Jun. 9, 2021.

(51) Int. Cl. C11D 3/04; C11D 1/00; C11D 3/43

(52) U.S. Cl. CPC C11D 3/042; C11D 1/008; C11D 3/43

(57) ABSTRACT

A detergent additive comprising (i) a biochelant; (ii) a ring-opener, and (iii) a solvent. A method of treating a contaminated surface comprising contacting a detergent and a detergent additive with the contaminated surface wherein the detergent additive comprises (i) a biochelant; (ii) a ring-opener, and (iii) a solvent.

### CROSS-REFERENCE TO RELATED APPLICATIONS

This application is a 35 U.S.C. § 371 national stage application of PCT/US2022/032868 filed Jun. 9, 2022, and entitled “Bio-Based Cleaner Additive,” which claims priority to U.S. Provisional Application Ser. No. 63/208,601 filed Jun. 9, 2021 and entitled “BIO-BASED CALCIUM CHELANT,” U.S. Provisional Application Ser. No. 63/203,634 filed Jul. 27, 2021 and entitled “BIO-BASED CALCIUM CHELANT,” and U.S. Provisional Application Ser. No. 63/253,066 filed Oct. 6, 2021 and entitled “BIO-BASED CLEANER ADDITIVE,” each of which is incorporated herein by reference in its entirety for all purposes.

### FIELD

The present disclosure relates generally to compositions and methods for use in the removal of contaminants. More particularly, the present disclosure relates to biochelant-containing compositions for use as a cleaning additive.

### BACKGROUND

Cleaning solutions such as laundry detergents may contain various components, examples of which include builders (e.g., 50% by weight, approximately), surfactants (e.g., 15%), bleaches (e.g., 7%), enzymes (e.g., 2%), soil anti-deposition agents, foam regulators, corrosion inhibitors, optical brighteners, dye transfer inhibitors, fragrances, dyes, fillers, and formulation aids. Detergent builders (also called chelating or sequestering agents) may function as water softeners. Most domestic water supplies contain some dissolved minerals, especially in hard water areas. The metal cations present in these dissolved minerals, particularly calcium and magnesium ions, can react with surfactants to form soap scum, which is much less effective for cleaning and can precipitate onto both fabric and washing machine components. Detergent builders may be effective to reduce or remove mineral ions (e.g., calcium ions) responsible for hard water through precipitation, chelation, or ion exchange. In addition, detergent builders may help to remove soil by dispersion. Detergent builders and surfactants may work synergistically to achieve soil removal. However, the washing effect of the builder may exceed that of the surfactant.

### SUMMARY

Disclosed herein is a detergent additive comprising (i) a biochelant; (ii) a ring-opener; and (iii) a solvent.

Also, disclosed herein is a method of treating a contaminated surface comprising contacting a detergent and a detergent additive with the contaminated surface wherein the detergent additive comprises (i) a biochelant; (ii) a ring-opener; and (iii) a solvent.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a plot of Delta E as a function of sample composition in a water having 150 ppm hardness value.

FIG. 2 is a plot of Delta E as a function of sample composition in a water having 300 ppm hardness value.

FIG. 3 is a plot of the cleaning efficiency as a function of sample composition for the samples from Example 4.

FIG. 4 is a plot of the cleaning efficiency as a function of sample composition for the samples from Example 5.

### DETAILED DESCRIPTION

Common chelating agents used as cleaning additives, or more specifically as detergent builders include, but are not limited to trisodium phosphate and other phosphonates, ethylenediaminetetraacetic acid (EDTA), nitrilotriacetic acid (NTA), methylglycinediacetic acid (MGDA), glutamic acid, N, N-diacetic acid (GLDA), ethylenediamine-N,N′-disuccinic acid (EDDS), diethylenetriaminepentaacetic acid (DTPA), hydroxyethylethylenediaminetriacetic acid (HEDTA), ethanoldiglycine (EDG), and glucoheptonate.

Utilization of the aforementioned chelating agents suffer from drawbacks associated with their negative effects on the environment and performance limitations. For example, phosphates, while effective, have significant issues related to eutrophication, while NTA is a known eye, skin, and respiratory irritant. Further examples include MGDA whose synthesis is problematic, as it still uses cyanide to introduce the carboxyl groups to the backbone of alanine. Finally, EDTA, a common chelating agent, which is not biodegradable, is known to be a persistent pollutant in the environment. EDTA is also shown to produce adverse reproductive and developmental effects in mammals.

Consequently, there exists an ongoing need for novel cleaning additives that function as detergent builders which will overcome some of the challenges associated with the use of conventional detergent builders.

Disclosed herein are compositions for use as cation chelant additives (CCA). In one or more aspects, the CCAs may be included in detergent compositions in order to sequester metal cations and mitigate the formation of metal cation-based scales. For example, the metal cation may comprise Ca⁺², Mg⁺², Mn⁺², Al⁺³, Fe⁺³ or combinations thereof. For example, a CCA of the type disclosed herein may be utilized as a detergent builder in an auto-dishwasher detergent, a manual dishwasher detergent, a laundry detergent, a surface cleaner, a toilet cleaner, a car-wash detergent, and other soaps and detergents.

In an aspect, the CCA comprises a biochelant, a ring opener, and a solvent. Additionally, in an aspect, the CCA further comprises performance additives such as carboxylates, sugar acids, surfactants, polymers, or combinations thereof.

In an aspect, the CCA comprises a chelant. Herein, a chelant, also termed a sequestrant, a chelating agent, or a sequestering agent, refers to a molecule capable of bonding or forming a complex with a metal. The chelant may be characterized as a ligand that contains two or more electron-donating groups, for example, so that more than one bond can be formed between an atom on each of the electron donating groups of the ligand to the metal. The bond can also be dative or a coordinating covalent bond meaning each electronegative atom provides both electrons to form bonds to the metal center. In an aspect, the chelant is a biochelant. As used herein, the prefix “bio” indicates that the chemical is produced, at least in part, by a biological process such as using an enzyme catalyst. Herein, the biochelant is characterized as being of a natural origin, from a sustainable, renewable resource having and with a low environmental impact. In an aspect, the biochelant comprises aldonic acid, uronic acid, aldaric acid, or combinations thereof and a counter cation. For example, the biochelant may be a mixture of aldaric, uronic acids, and their respective counter-cations. In an aspect, the biochelant comprises a glucose oxidation product, a gluconic acid oxidation product, a gluconate, or combinations thereof. The glucose oxidation product, gluconic acid oxidation product, or combination thereof may be buffered to a suitable pH. Additionally or alternatively, in one or more aspects, the biochelant comprises glucaric acid, gluconic acid, glucuronic acid, glucose oxidation products, gluconic acid oxidation products, or combinations thereof. Additionally or alternatively, in one or more aspects, the biochelant comprises disaccharides, oxidized disaccharides, uronic acid, aldaric acid, or combinations thereof.

Additionally or alternatively, in one or more aspects, the biochelant comprises gluconic acid, glucaric acid, glucuronic acid, n-keto-acids, C₂ to C₆ diacids, or combinations thereof. Additionally, or alternatively, in one or more aspects, the biochelant comprises galactonic acid, galactaric acid, an oxidation product comprising predominantly (e.g., greater than about 50 weight percent) galactonic acid and/or galactaric acid with minor component species of n-keto-acids, C₂ to C₆ diacids, or combinations thereof. Additionally, or alternatively, in one or more aspects, the biochelant comprises glutamic acid. Additionally or alternatively, in one or more aspects, the biochelant comprises glucodialdose, 2-ketoglucose, or combinations thereof. In such aspects, the buffered glucose oxidation product, the buffered gluconic acid oxidation product, or combinations thereof are buffered to a suitable pH. For example, the glucose oxidation product, gluconic acid oxidation product, or combination thereof may be buffered to a pH in the range of from about 1 to about 5. Buffering of the biochelant may be carried using any suitable acid, base or combination thereof. In one or more aspects, any biochelant or combination of biochelants disclosed herein may further comprise a counter-cation such as a Group 1 alkali metal, a Group 2 alkaline earth metal, a Group 8 metal, a Group 11 metal, a Group 12 metal, or combinations thereof. For example, the counter-cation may comprise silicates, borates, aluminum, calcium, magnesium, ammonium, sodium, potassium, cesium, strontium, zinc, copper, ferric iron or ferrous iron, or combinations thereof. In an aspect, the biochelant comprises a glucose oxidation product, a gluconic acid oxidation product, a gluconate, glucaric acid, an oxidized glucuronolactone, a uronic acid oxidation product, or combinations thereof. Additionally or alternatively, the biochelant comprises a buffered glucose oxidation product, a buffered gluconic acid oxidation product, or combinations thereof. In some such aspects, the buffered glucose oxidation product, the buffered gluconic acid oxidation product, or combinations thereof are buffered to a pH within a range disclosed herein with any suitable acid or base such as sodium hydroxide. In an example, the biochelant comprises a mixture of gluconic acid and glucaric acid, and further comprises a minor component species comprising n-keto-acids, C₂-C₆ diacids, or combinations thereof. In an aspect, the biochelant comprises a metal chelation product commercially available from Solugen, Houston, Texas as BIOCHELATE™, Altiv™, AcquaCore™.

In an aspect, the biochelant is present in a CCA of the present disclosure in an amount of from about 0.1 weight percent (wt. %) to about 40 wt. % based on the total weight of the composition, additionally or alternatively from about 0.1 wt. % to about 20 wt. %, additionally or alternatively from about 0.1 wt. % to about 95 wt. %, additionally or alternatively from about 5 wt. % to about 95 wt. %, or additionally or alternatively from about 20 wt. % to about 40 wt. % based on the total weight of the CCA.

In an aspect, the CCA comprises a ring-opener. Historically, glucaric acid and gluconic acid are poor calcium ion chelators. Not intending to be bound by theory, this is due to the fact that the carboxylate of these compounds form lactones. Such lactones are in constant equilibrium with the acid (e.g., carboxylic acid) form of the molecule. However, the acid form is the most effective in chelating certain divalent cations such as calcium as depicted in Scheme I and Scheme II below. As a general result, gluconates and glucarates have not been used widely to chelate cations such as calcium cations in detergent formulations. In an aspect, the CCA comprises a compound that functions to shift the equilibrium between the carboxylate and lactone form of glucaric acid and gluconic acid to favor retention of the linear glucaric acid and ensure the amount of the lactone form is minimized.

In an aspect, the ring opener comprises an oxoacid salt, an amide, or combinations thereof. For example, the ring opener may comprise silicic acid, sodium silicate, potassium silicate, monosilicate, silanes, siloxanes, boric acid, aluminates, sodium molybdate, urea, acetamide, ethanamide, derivatives thereof, or combination thereof. In an aspect, the ring opener comprises a urea compound. Examples of urea compounds suitable for use as ring openers in the present disclosure include without limitation methylol urea, imidazolidinyl urea, ethylene urea, diazolidnyl urea or combinations thereof. In an aspect, the ring opener is an amino acid, such as glycine, proline, alanine, serine, taurine, sarcosine, amino adipic acid, and glutamic acid. In another aspect, the ring opener is a borate derivative, such as borax, sodium borates (metaborate, perborate), potassium borates, diammonium tetraborate, and boron trioksit.

In an aspect, the ring-opener is present in the CCA in an amount ranging from about 2 weight percent (wt. %).% to about 95 wt. %, alternatively from about 5 wt. % to about 95 wt. %, additionally or alternatively from about 2 wt. % to about 80 wt. %, additionally or alternatively from about 10 weight percent (wt. %) to about 40 wt. %, additionally or alternatively from about 2 wt. % to about 30 wt. %, or additionally or alternatively from about 30 wt. % to about 80 wt. % based on to total weight of the CCA. Other factors that may influence the amount of ring opener utilized is the compound's solubility, molar ratio, water conditions, and pH.

In an aspect, the CCA is effective to substantially chelate or sequester common cations such as calcium, magnesium, iron, potassium, barium, strontium, cesium, beryllium, and manganese.

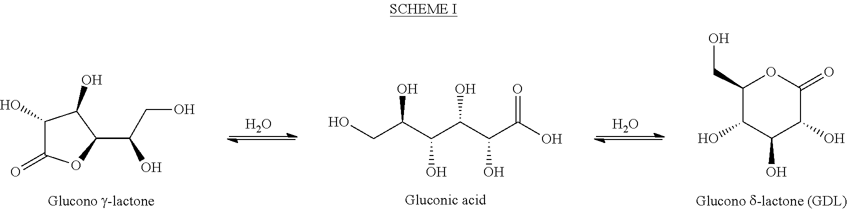 [SMILES: O=C1O[C@H]([C@H](O)CO)[C@H](O)[C@H]1O ; O ; O=C(O)[C@H](O)[C@@H](O)[C@H](O)[C@H](O)CO ; O ; O=C1O[C@H](CO)[C@@H](O)[C@H](O)[C@H]1O]

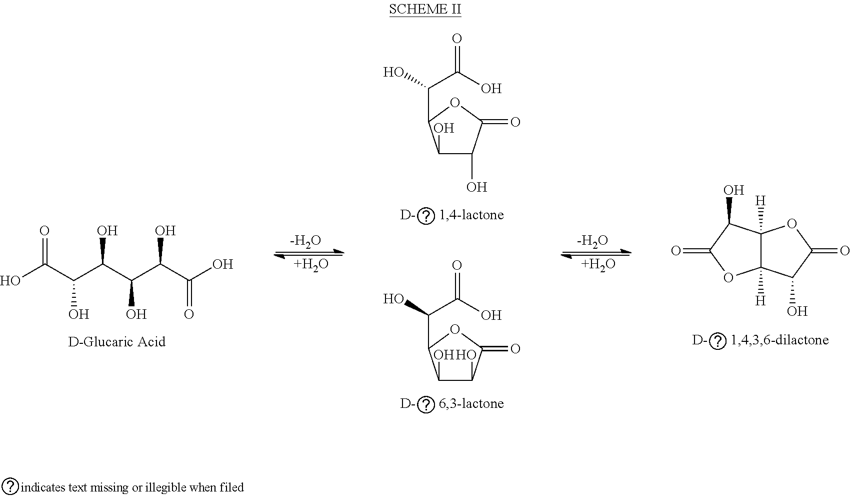

In some aspects, the CCA excludes a non-biochelant chelating agent. Alternatively, the CCA may include one or more non-biochelant chelating agents, for example, in addition to the biochelant. Nonlimiting examples of non-biochelant chelating agents suitable for use in the present disclosure include trisodium phosphate, phosphonate-containing compounds, lactic acid, citric acid, ethylenediaminetetraacetic acid, nitrilotriacetic acid, methylglycinediacetic acid, glutamic acid N,N-diacetic acid, ethylenediamine-N,N′-disuccinic acid, diethylenetriaminepentaacetic acid, hydroxyethylethylenediaminetriacetic acid, ethanoldiglycine, and combinations thereof.

Without wishing to be limited by theory, other compounds may be included in the CCA as a result of their ability to prevent formation of the lactone form. Other additives that prevent formation of the lactone form of glucaric acid and gluconic acid include carboxylate-containing compounds, sugar alcohols, and acids. Other nonlimiting examples of such additives include methanonic acid, ethanoic acid, sulfamic acid, sulfonic acid, propanoic acid, benzoic acid, acrylic acid, lactic acid, pyruvic acid, butyric acid, succinic acid, fumaric acid, and combinations thereof.

In various aspects, the CCA comprise one or more surfactants that aid in the performance of the CCA. In an aspect, the surfactant is nonionic, zwitterionic, cationic, or anionic. Nonlimiting examples of surfactants suitable for use in the CCA include cocamide monoethanolamine (cocamide MEA), sodium lauryl sulfate, sodium dodecyl sulfate ammonium lauryl sulfate, linear alkylbenzene sulfonate, linear alcohol ethoxylated sulfonates, highly soluble alcohol sulfates, cocamide diethanolamine, fatty alcohol ethoxylates, amine oxides, sulfoxides, quaternary ammonium surfactants, tall oil fatty acids (TOFA), TOFA amines, TOFA quaternary amines, COCO amines, COCO quaternary amines, benzalkonium chloride, betaines, coco betaine, sultaines, terpenes, limonene, ethoxylated triglyceride, polysorbates, ethoxylated sorbitol, sorbitan esters, and combinations thereof.

In some aspects, the CCA further comprises a performance enhancing polymer. Nonlimiting examples of performance enhancing polymers suitable for use in the present disclosure include polyacrylates, maleic-acrylates, polyolefins, cellulose ethers, polyethers, maleic-olefins, styrene-acrylates, anionic polysaccharides, polyvinyl alcohol and polyvinyl alcohol-acetate, and combinations thereof.

In an aspect, a CCA of the type disclosed herein may comprise one or more additional functional materials to meet some user and/or process goal. Examples of functional materials that may be included in the CCA include without limitation rinse aids, bleaching agents, sanitizers, anti-microbial agents, activators, fillers, pH buffering agents, fabric relaxants, fabric softeners, soil releasing agents, defoaming agents, anti-redeposition agents, stabilizing agents, dispersants, optical brighteners, anti-static agents, anti-wrinkling agents, odor-capturing agents, fiber protection agents, color protection agents, dyes, odorants, UV-protection agents, antipilling agents, water repellency agents, hardening agents, solubility modifiers, glass and metal corrosion inhibitors, enzymes, anti-scaling agents, oxidizing agents, solvents, insect repellants, or combinations thereof. Such functional materials may be included singularly or in combination in amounts effective to meet some user and/or process goal.

In an aspect, a CCA comprises a solvent. Solvents suitable for use in the present disclosure include, without limitation, water, methanol, ethanol, ethylene glycol, propylene glycol, ethylene glycol monobutyl ether, or combinations thereof. In an aspect, the solvent is present in an effective amount; alternatively, the solvent comprises the remainder of the CCA when all other components of the CCA are accounted for.

A CCA of the type disclosed herein may be prepared using any suitable methodology. For example, the components of the CCA (e.g., biochelant, ring-opener and solvent) may be combined in any order, in any suitable vessel and mixed to form a homogeneous composition.

CCAs of the type disclosed herein are preferable to conventional technologies that utilize toxic feedstock and/or lead to harmful byproducts. Preparation of the presently disclosed compositions does not utilize carcinogenic, mutagenic, or toxic chemistries such as those processes utilizing cyanide and ethylenediamine. Without wishing to be limited by theory, the CCAs avoid complex lactone chemistries and while promoting the carboxylate form that chelates cations effectively.

### ADDITIONAL DISCLOSURE

The following are non-limiting, specific aspects in accordance with the present disclosure:

A first aspect which is a composition for a detergent builder utilizing a biochelant and a ring opener.

A second aspect which is the composition of the first aspect wherein the chelant and organic acid comprises of sodium gluconate and/or sodium glucarate liquid oxidation product comprising predominantly gluconate and glucarate anions with minor component species of n-keto-acids and C₂-C₆ diacids.

A third aspect which is the composition of any of the first and second aspects wherein the chelant and organic acid comprises of gluconic acid and glucaric acid oxidation product comprising predominantly gluconic acid and/or glucaric acid with minor component species of n-keto-acids and C₂-C₆ diacids.

A fourth aspect which is the composition of any of the first through third aspects wherein the ring opener comprises of oxoacid salts.

A fifth aspect which is the composition of the fourth aspect wherein the oxoacid salt comprises of silicates, borates, aluminates, titanates, stannate, or mixtures, derivatives, or combinations, thereof.

A sixth aspect which is the composition of any of the first through fifth aspects wherein the ring opener comprises of silanes, siloxanes, mixtures, or derivatives, or combinations thereof.

A seventh aspect which is the composition of the sixth aspect wherein the ring opener comprises of amides.

An eighth aspect which is the composition of the seventh aspect wherein the amide comprises of urea, acetamide, ethanamide, mixtures, or derivatives, or combinations thereof.

A ninth aspect which is the composition of any of the first through eighth aspects wherein the solvent comprises water, methanol, ethanol, ethylene glycol, propylene glycol, ethylene glycol monobutyl ether, or combinations thereof.

A tenth aspect which is the composition of any of the first through ninth aspects further comprising one or more additional functional materials, each independently selected from the group consisting of rinse aids, bleaching agents, sanitizers, anti-microbial agents, activators, detergent builders or fillers, pH buffering agents, fabric relaxants, fabric softeners, soil releasing agents, defoaming agents, anti-redeposition agents, stabilizing agents, dispersants, optical brighteners, anti-static agents, anti-wrinkling agents, odor-capturing agents, fiber protection agents, color protection agents, dyes, odorants, UV-protection agents, antipilling agents, water repellency agents, hardening agents, solubility modifiers, glass and metal corrosion inhibitors, enzymes, anti-scaling agents, oxidizing agents, solvents, and insect repellants.

### Part II

A first aspect which is a composition for a detergent builder utilizing a biochelant and a ring opener.

A second aspect which is the composition of the first aspect wherein the chelant and organic acid comprises of sodium gluconate and/or sodium glucarate liquid oxidation product comprising predominantly gluconate and glucarate anions with minor component species of n-keto-acids and C₂-C₆ diacids.

A third aspect which is the composition of any of the first through second aspects wherein the chelant and organic acid comprises of gluconic acid and glucaric acid oxidation product comprising predominantly gluconic acid and/or glucaric acid with minor component species of n-keto-acids and C₂-C₆ diacids.

A fourth aspect which is the composition of any of the first through third aspects wherein the ring opener comprises of oxoacid salts.

A fifth aspect which is the composition of the fourth aspect wherein the oxoacid salt comprises of silicates, borates, aluminates, titanates, stannate, molybdates, or combinations, mixtures, or derivatives thereof.

A sixth aspect which is the composition of any of the first through fifth aspects wherein the ring opener comprises of silanes, siloxanes or combinations, mixtures, or derivatives thereof.

A seventh aspect which is the composition of any of the first through sixth aspects wherein the ring opener comprises of amides and amino acids.

An eighth aspect which is the composition of the seventh aspect wherein the amide comprises of urea, acetamide, ethanamide, or combinations, mixtures, or derivatives thereof.

A ninth aspect which is the composition of any of the first through eighth aspects wherein the solvent comprises water, methanol, ethanol, ethylene glycol, propylene glycol, ethylene glycol monobutyl ether, or combinations thereof.

A tenth aspect which is the composition of any of the first through ninth aspects where in the chelating agents comprises of lactic acid, citric acid, trisodium phosphate and other phosphonates, ethylenediaminetetraacetic acid, nitrilotriacetic acid, methylglycinediacetic acid, glutamic acid N, N-diacetic acid, ethylenediamine-N,N′-disuccinic acid, diethylenetriaminepentaacetic acid, dydroxyethylethylenediaminetriacetic acid, ethanoldiglycine.

An eleventh aspect which is the composition of any of the first through tenth aspects further comprising one or more additional functional materials, each independently selected from the group consisting of rinse aids, bleaching agents, sanitizers, anti-microbial agents, activators, detergent builders or fillers, pH buffering agents, fabric relaxants, fabric softeners, soil releasing agents, defoaming agents, anti-redeposition agents, stabilizing agents, dispersants, optical brighteners, anti-static agents, anti-wrinkling agents, odor-capturing agents, fiber protection agents, color protection agents, dyes, odorants, UV-protection agents, antipilling agents, water repellency agents, hardening agents, solubility modifiers, glass and metal corrosion inhibitors, enzymes, anti-scaling agents, oxidizing agents, solvents, surfactants, and insect repellants.

### Part III

A first aspect which is a detergent additive comprising (i) a biochelant; (ii) a ring-opener; and (iii) a solvent.

A second aspect which is the additive of the first aspect wherein the biochelant comprises an aldonic acid, uronic acid, aldaric acid or combinations thereof.

A third aspect which is the additive of any of the first through second aspects wherein the biochelant further comprises a counter cation.

A fourth aspect which is the additive of the third aspect wherein the counter cation comprises a Group 1 alkali metal, a Group 2 alkaline earth metal, a Group 8 metal, a Group 11 metal, a Group 12 metal, or combinations thereof. For example, the counter-cation may comprise.

A fifth aspect which is the additive of the third aspect wherein the counter cation comprises silicates, borates, aluminum, calcium, magnesium, ammonium, sodium, potassium, cesium, strontium, zinc, copper, ferric iron or ferrous iron, or combinations thereof.

A sixth aspect which is the additive of any of the first through fifth aspects wherein the biochelant comprises a buffered glucose oxidation product, a buffered gluconic acid oxidation product or combinations thereof.

A seventh aspect which is the additive of the sixth aspect wherein the buffered glucose oxidation product, the buffered gluconic acid oxidation product or combinations thereof further comprises n-keto-acids, C₂-C₆ diacids or combinations thereof.

An eighth aspect which is the additive of any of the first through seventh aspects wherein the biochelant is present in an amount of from about 5 wt. % to about 95 wt. % based on the total weight of the additive.

A ninth aspect which is the additive of any of the first through eighth aspects wherein the ring opener comprises silicic acid, sodium silicate, potassium silicate, monosilicate, sodium molybdate, urea, boric acid, aluminates, urea, acetamide, ethanamide, derivatives thereof, or combinations thereof.

A tenth aspect which is the additive of any of the first through ninth aspects wherein the ring opener is present in an amount of from about 5 wt. % to about 95 wt. % based on the total weight of the additive.

An eleventh aspect which is the additive of any of the first through tenth aspects wherein the solvent comprises water, methanol, ethanol, ethylene glycol, propylene glycol, ethylene glycol monobutyl ether, or combinations thereof.

A twelfth aspect which is the additive of any of the first through eleventh aspects further comprising a conventional chelating agent.

A thirteenth aspect which is the additive of the twelfth aspect wherein the conventional chelating agent comprises trisodium phosphate and other phosphonates, acid, lactic acid, citric ethylenediaminetetraacetic acid, nitrilotriacetic acid, methylglycinediacetic acid, glutamic acid N,N-diacetic acid, ethylenediamine-N,N′-disuccinic acid, diethylenetriaminepentaacetic acid, hydroxyethylethylenediaminetriacetic acid, ethanoldiglycine, or combination thereof.

A fourteenth aspect which is the additive of any of the first through thirteenth aspects further comprising a performance enhancing compound.

A fifteenth aspect which is the additive of the fourteenth aspect wherein the performance enhancing compound comprises methanonic acid, ethanoic acid, sulfamic acid, sulfonic acid, propanoic acid, benzoic acid, acrylic acid, lactic acid, pyruvic acid, butyric acid, succinic acid, fumaric acid, malic acid, citric acid, sorbitol, mannitol, or combinations thereof.

A sixteenth aspect which is the additive of any of the first through fifteenth aspects further comprising a surfactant.

A seventeenth aspect which is the additive of the sixteenth aspect wherein the surfactant comprises cocamide monoethanolamine (cocamide MEA), sodium lauryl sulfate, sodium dodecyl sulfate ammonium lauryl sulfate, linear alkylbenzene sulfonate, linear alcohol ethoxylated sulfonates, highly soluble alcohol sulfates, cocamide diethanolamine, fatty alcohol ethoxylates, amine oxides, sulfoxides, quaternary ammonium surfactants, tall oil fatty acids (TOFA), TOFA amines, TOFA quaternary amines, COCO amines, TOFA quaternary amines, benzalkonium chloride, betaines, coco betaine, sultaines, terpenes, limonene, ethoxylated triglyceride, polysorbates, ethoxylated sorbitol, sorbitan esters or combinations thereof.

An eighteenth aspect which is the additive of any of the first through seventeenth aspects further comprising a performance enhancing polymer.

A nineteenth aspect which is the additive of the eighteenth aspect wherein the performance enhancing polymer comprises polyacrylates, maleic-acrylates, polyolefins, cellulose ethers, polyethers, maleic-olefins, styrene-acrylates, anionic polysaccharides, polyvinyl alcohol, polyvinyl alcohol-acetate, or combinations thereof.

A twentieth aspect which is a method of treating a contaminated surface comprising contacting a detergent and a detergent additive with the contaminated surface wherein the detergent additive comprises i) a biochelant; (ii) a ring-opener; and (iii) a solvent.

A twenty-first aspect which is the method of the twentieth aspect wherein the chelant comprises aldonic acid, uronic acid, aldaric acid or combinations thereof; wherein the ring opener comprises silicic acid, sodium silicate, potassium silicate, monosilicate, sodium molybdateurea, boric acid, aluminates, urea, acetamide, ethanamide, derivatives thereof, or combinations thereof, and wherein the solvent comprises water.

### EXAMPLES

The presently disclosed subject matter having been generally described, the following examples are given as particular aspects of the subject matter and to demonstrate the practice and advantages thereof. It is understood that the examples are given by way of illustration and are not intended to limit the specification or the claims in any manner.

### Example 1

The chelating capacity of a CCA of the type disclosed herein was investigated in accordance with the AATCC 149 test method. The AATCC 149 test method is a method routinely employed to determine the chelating capacity of common chelants. This titration method allows a repeatable measurement to determine CaCV (Calcium Chelation Value), measured in mg Ca/g chelant. The experiment was carried out by adding about 0.4 g to about 0.8 g of active material into a 250 mL flask to which was added 85 mL of deionized water and the mixture stirred. To this mixture 5 drops of 50% NaOH solution was added and the mixture stirred. However, 10 drops of NaOH were added if the free acid form of the chelating agent was used. To this mixture 1 mL of the pH 12 or pH 11 buffer solution was added and the solution stirred before adding 10 mL sodium oxalate solution followed by a calcium solution until persistent turbidity occurred. The results of the tests are shown in the tables below.

TABLE 1

| | CaCV (mg | Moles of Ring |
|---|---|---|
| | CaCO₃/g | Opener to |
| Reagent | chelant) | Glucaric Acid |
| Sodium citrate | 102 | N/A |
| EDTA | 274 | N/A |
| MGDA | 297 | N/A |
| Glucaric acid + aluminate | 402 | 1.2 |
| Glucaric acid + urea | 488 | 1.2 |
| Glucaric acid + boric acid | 282 | 1.2 |
| Glucaric acid + silicic acid | 377 | 1.2 |
| Glucaric acid + sodium silicate | 465 | 0.25 |
| Glucaric acid | 13 | N/A |
| Gluconic acid | 6 | N/A |
| Gluconic/Glucaric mixture | 38 | N/A |

The values in Tables 1 and 2 have been normalized for activity. The derivates of glucaric acid all outperformed the non-derivatized versions, and also outperformed sodium citrate, and the traditional chelants.

The most surprisingly advantageous result was observed for the CCA comprising glucaric acid and urea or glucaric acid and sodium silicate. The sodium silicate was added at a sub-stoichiometric ratio which potentially can result in multiple moles of glucaric acid reacting with silicate, resulting in multiple terminal carboxyl groups being present.

As shown in Table 1, the CCAs disclosed herein outperform incumbent carboxylates technology. This is due to control of the complex lactone chemistries and orientation of the carboxylate to chelate the cations effectively.

In some aspects, the CCA disclosed herein is a novel, metal-free calcium chelating agent that outperforms incumbent chelating agents such as MGDA, EDTA, and GLDA. This is an unexpectedly beneficial result as glucaric acid has a maximum of 2 terminal carboxyl groups to chelate calcium, while MGDA and other compounds have 3 terminal carboxyl groups.

### Example 2

A modified ASTM D3556 test was used to determine the efficacy of different detergent builders in an auto-dishwashing/warewashing/dishwater application was performed. Specifically, 4 grams of a soiling composition which was a mixture of margarine and powdered milk was used to coat the inner surface of a clear glass container, and a CCA of the type disclosed herein was applied to the clear glass container. The CCA specific formulation is presented in Table 2.

TABLE 2

| Ingredient | % wt (active) | Function |
|---|---|---|
| Sodium Silicate | 2 | Builder |
| Polyacrylate | 1 | Polymeric enhancer |
| Active Chelant | 20 | Builder |
| NaOH | 20 | |
| Water | Balance | |

The test utilized the following cycles, using Houston tap water with 145 ppm hardness, a 29 minute washing time, a hot wash (50° C.), cold rinse, hot rinse (62° C.) and used the same locations in dishwasher (front/rear). The total water that was consumed is approximately 5 liters, and 5 mL of the total formulation was used in each run. The results are presented in Table 3.

TABLE 3

| Run | Additive | Clear glass |
|---|---|---|
| 1 | Zirconate - glucaric mixture | Yes |
| 2 | Silicate - glucaric mixture | Yes |
| 3 | Aluminate - glucaric mixture | Yes |
| 4 | Sodium Citrate | No, Hazy |
| 5 | EDTA | No, Hazy |
| 6 | MGDA | No, Hazy |

As seen in the Table 3, the glucaric based mixtures had the clearest glasses, indicating higher detergent builder/chelating agent performance.

### Example 3

The CCA was also evaluated in other cleaning applications. Specifically, a Tergotometer test was performed to determine the efficacy of glucaric acid based products in laundry. The formulation used is presented in Table 4 where CALSUDS L-60 is an odorless, hazy and opalescent paste at room temperature solution of sodium linear alkylbenzene sulfonate and MASODOL 25-7 is a linear primary alcohol ethoxylate nonionic surfactant characterized by high surface activity and low aquatic toxicity. The experiment was conducted using 150 ppm hardness water and fabric swatches of the following clay on cotton, dust and sebum on cotton, dust and sebum on CPDP (polyester), EMPA 101 (carbon black/olive oil) on cotton and EMPA 104 (carbon black/olive oil) on CPDP (polyester). The extent of color removal, Delta E, was determined using a colorimeter such that the higher the Delta E, the better the color removal.

The CIE L*, a*, b* values of cleaned fabric swatches were measured using a colorimeter with a UV filter. Each of the swatches for each fabric type were measured twice and then stacked on top of each other during measurement, (as per recommendations from Hunter lab outlined in the bulletin “Measuring Fabric Using the Lab Scan”). The first measurement was taken and then the swatch was turned 90° and the second measurement was taken. The six measurements were averaged and recorded. The CIE L*, a*, b* values are then used to calculate the delta E, Equation I, which is a change in the color of the stained fabric.

$$Delta E = \sqrt{{( L 1 - L 2 )}^{2} + {( a 1 - a 2 )}^{2} + {( b 1 - b 2 )}^{2}} \qquad ( Equation 1 )$$

where the variables represent the following: L*1 is the initial L* value, L*2 is the final L* value, a*1 is the initial a* value, a*2 is the final a* value, b*1 is the initial b* value, b*2 is the final b* value

TABLE 4

| Ingredient | wt. % (active) | Function |
|---|---|---|
| CCA | 0.8 | Builder |
| CALSUDS L-60 | 15.0 | Surfactant |
| MASODOL 25-7 | 5.0 | Surfactant |
| Silicate | 2.0 | Builder |
| Water | Balance | Solvent |

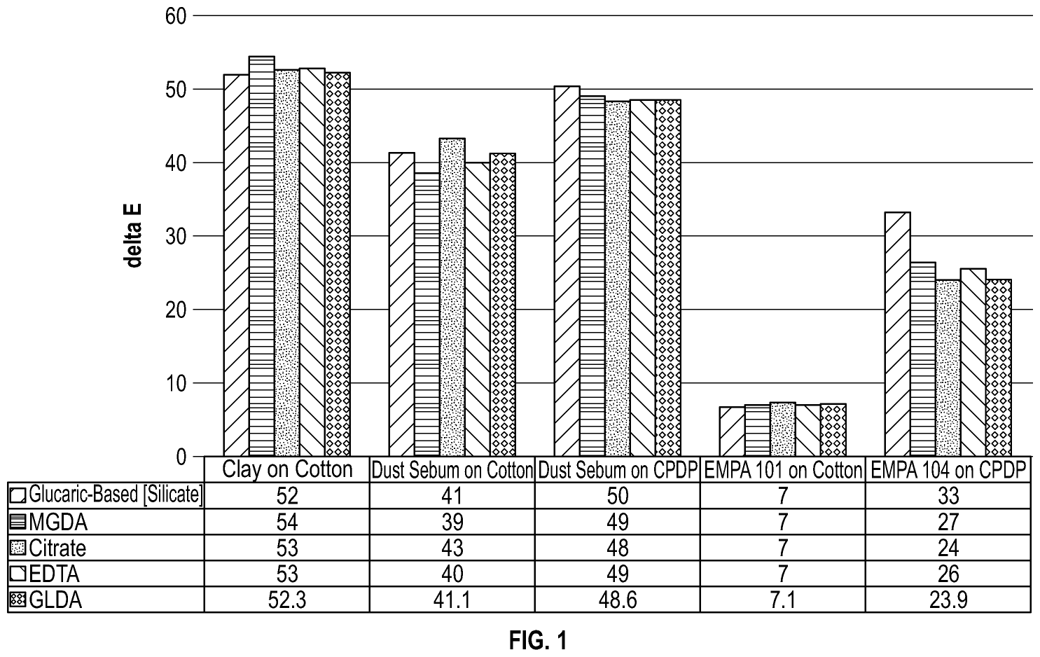

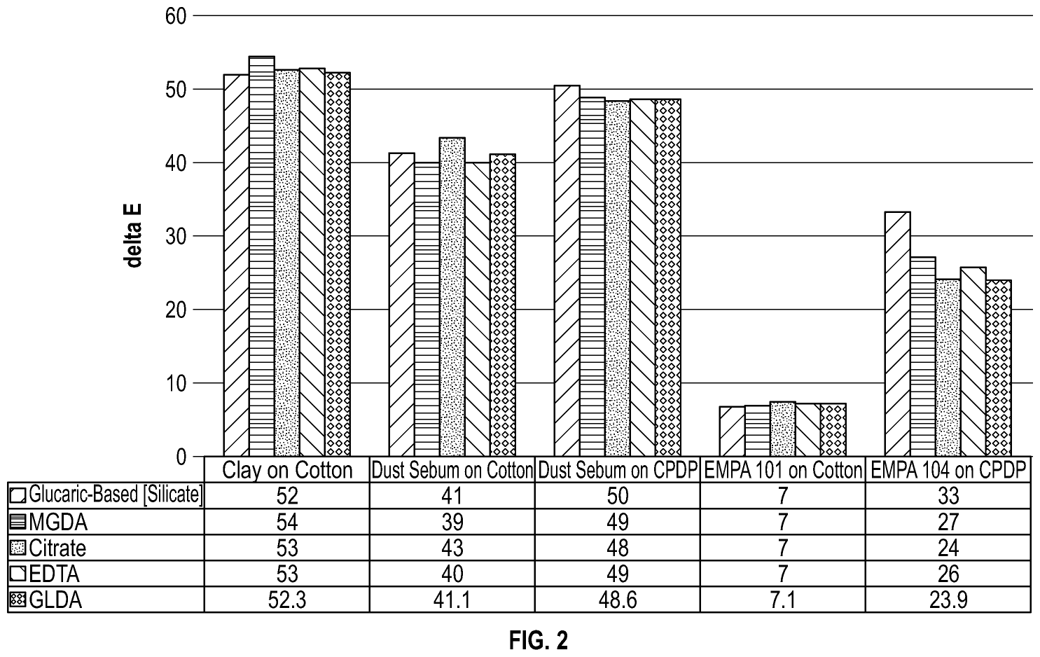

The results of the terg testing using a 150 ppm hardness water is shown in FIG. 1 while the results using a 300 ppm hardness water is shown in FIG. 2. Specifically, FIGS. 1 and 2 are plots of the Delta E value as a function of the sample compositions. Referring to FIG. 1, the glucaric builder is competitive with incumbents, but it outperformed all of the incumbents with the EMPA 104 run, which is the carbon black/olive oil on polyester. FIG. 2 similarly displays the advantages observed with the CCA under harsher conditions of a 300 ppm hardness water.

### Example 4

A series of hard surface cleaning tests were performed to determine the efficacy of the CCA in other applications and environments. ADCC-16 test was performed in an acidic formulation. The CCA formulation is shown in Table 5.

TABLE 5

| Ingredient | % wt. (active) | Function |
|---|---|---|
| Methanesulfonic Acid | 1.2 | pH Source |
| Active Builder | 1.5 | Builder |
| Butyl Diglycol | 1.5 | Solvent |
| C9-11 linear alcohol ethoxylate | 1.2 | Surfactant |
| Water | Balance | Solvent |

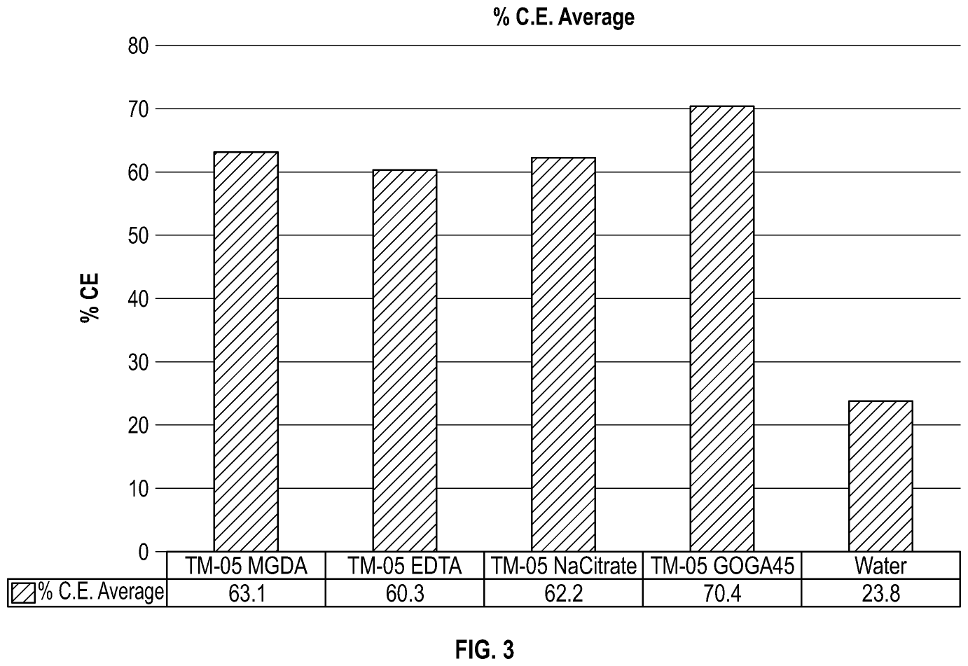

The test method utilized a mixture of bar soap, shampoo, clay, artificial sebum, and hard water on tile. The cleaning efficiency is measured by measuring the change in reflectance of the original, cleaned, and soiled tile. The higher the number, the higher the performance of the formulation. The cleaning efficiency is shown in Equation 2.

$$\% Cleaning efficiency = \frac{Rc - Rs}{Ro - Rs} * 100 \qquad ( Equation 2 )$$

where R_{c} is the cleaned reflectance, Rₒ is the original reflectance and Rₛ is the soiled reflectance. The results are presented in FIG. 3 which is a plot of the percentage cleaning efficiency (% C.E.) as a function of sample composition. With reference to FIG. 3 the GOGA45 (a crude glucaric acid and gluconate product) performed significantly higher than the incumbent builders.

### Example 5

A series of hard surface cleaning tests were performed to determine the efficacy of a CCA in other applications and environments, specifically with a complex soil with iron oxide, clay, oils, cement, and silica with a water hardness of 300 ppm. The test was conducted in accordance with ASTM D4488-95. The CCA formulation is shown in Table 6.

TABLE 6

| Ingredient | wt. % (active) | Function |
|---|---|---|
| APG C8-C10 | 7.0 | Surfactant |
| C9-11 linear alcohol ethoxylate | 3.0 | Surfactant |
| SLS | 4.5 | Surfactant |
| Active Builder | 4.0 | Builder |
| Water | Balance | Solvent |

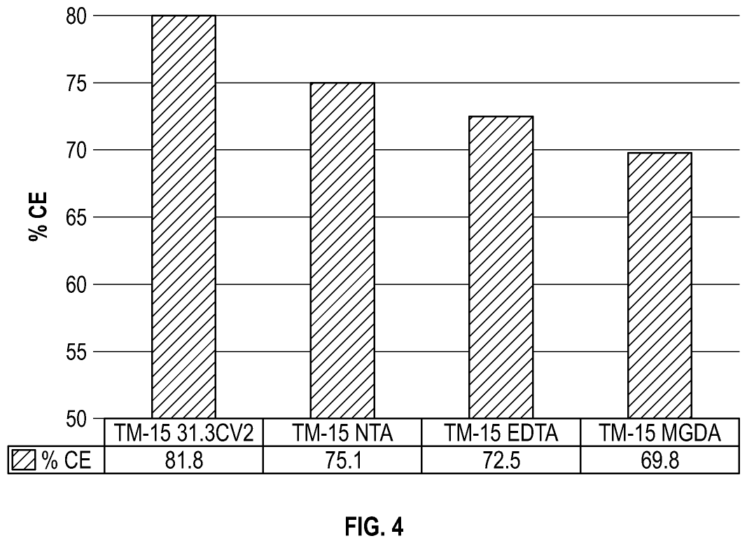

The ASTM test was modified to have only 2 scrub cycles, with a dosage of 2% of the product in water with 300 ppm hardness. The results are show in FIG. 4 where a higher CE score indicates a higher performance.

The subject matter having been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A detergent additive, comprising:
(i) a biochelant;
(ii) a ring-opener; and
(iii) a solvent.

2. The detergent additive of claim 1, wherein the biochelant comprises an aldonic acid, uronic acid, aldaric acid, galactonic acid, galactaric acid oxidation product comprising predominantly galactonic acid, galactaric acid with minor component species of n-keto-acids and C₂-C₆ diacids, or a combination thereof.

3. The detergent additive of claim 1, wherein the biochelant further comprises a counter cation.

4. The detergent additive of claim 3, wherein the counter cation comprises a Group 1 alkali metal, a Group 2 alkaline earth metal, a Group 8 metal, a Group 11 metal, a Group 12 metal, or a combination thereof.

5. The detergent additive of claim 3, wherein the counter cation comprises silicates, borates, aluminum, calcium, magnesium, ammonium, sodium, potassium, cesium, strontium, zinc, copper, ferric iron or ferrous iron, or a combination thereof.

6. The detergent additive of claim 1, wherein the biochelant comprises a buffered glucose oxidation product, a buffered gluconic acid oxidation product, or a combination thereof.

7. The detergent additive of claim 6, wherein the buffered glucose oxidation product, the buffered gluconic acid oxidation product or combinations thereof further comprises n-keto-acids, C₂-C₆ diacids, or a combination thereof.

8. The detergent additive of claim 1, wherein the biochelant is present in an amount of from about 5 wt. % to about 95 wt. % based on the total weight of the additive.

9. The detergent additive of claim 1, wherein the ring opener comprises silicic acid, sodium silicate, potassium silicate, monosilicate, sodium molybdateurea, boric acid, aluminates, urea, amides, amino acids, acetamide, ethanamide, titanates, stannates, molybdates, zirconates, silanes, siloxanes, derivatives thereof, or a combination thereof.

10. The detergent additive of claim 1, wherein the ring opener is present in an amount of from about 5 wt. % to about 95 wt. % based on the total weight of the additive.

11. The detergent additive of claim 1, wherein the solvent comprises water, methanol, ethanol, ethylene glycol, propylene glycol, ethylene glycol monobutyl ether, or a combination thereof.

12. The detergent additive of claim 1, further comprising a conventional chelating agent.

13. The detergent additive of claim 12, wherein the conventional chelating agent comprises trisodium phosphate and other phosphonates, lactic acid, citric acid, ethylenediaminetetraacetic acid, nitrilotriacetic acid, methylglycinediacetic acid, glutamic acid N,N-diacetic acid, ethylenediamine-N,N′-disuccinic acid, diethylenetriaminepentaacetic acid, hydroxyethylethylenediaminetriacetic acid, ethanoldiglycine, or a combination thereof.

14. The detergent additive of claim 1, further comprising a performance enhancing compound.

15. The detergent additive of claim 14, wherein the performance enhancing compound comprises methanonic acid, ethanoic acid, sulfamic acid, sulfonic acid, propanoic acid, benzoic acid, acrylic acid, lactic acid, pyruvic acid, butyric acid, succinic acid, fumaric acid, malic acid, citric acid, sorbitol, mannitol, or a combination thereof.

16. The detergent additive of claim 1, further comprising a surfactant.

17. The detergent additive of claim 16, wherein the surfactant comprises cocamide monoethanolamine (cocamide MEA), sodium lauryl sulfate, sodium dodecyl sulfate ammonium lauryl sulfate, linear alkylbenzene sulfonate, linear alcohol ethoxylated sulfonates, highly soluble alcohol sulfates, cocamide diethanolamine, fatty alcohol ethoxylates, amine oxides, sulfoxides, quaternary ammonium surfactants, tall oil fatty acids (TOFA), TOFA amines, TOFA quaternary amines, COCO amines, COCO quaternary amines, benzalkonium chloride, betaines, coco betaine, sultaines, terpenes, limonene, ethoxylated triglyceride, polysorbates, ethoxylated sorbitol, sorbitan esters, or a combination thereof.

18. The detergent additive of claim 1, further comprising a performance enhancing polymer.

19. The detergent additive of claim 18, wherein the performance enhancing polymer comprises polyacrylates, maleic-acrylates, polyolefins, cellulose ethers, polyethers, maleic-olefins, styrene-acrylates, anionic polysaccharides, polyvinyl alcohol, polyvinyl alcohol-acetate, or a combination thereof.

20. A method of treating a contaminated surface, the method comprising:
contacting a detergent and a detergent additive with the contaminated surface, wherein the detergent additive comprises (i) a biochelant; (ii) a ring-opener; and (iii) a solvent.

21. The method of claim 20 wherein the chelant comprises aldonic acid, uronic acid, aldaric acid or combinations thereof; wherein the ring opener comprises silicic acid, sodium silicate, potassium silicate, monosilicate, sodium molybdateurea, boric acid, aluminates, urea, acetamide, ethanamide, derivatives thereof, or a combination thereof, and wherein the solvent comprises water.
